(19) United States
(12) Patent Application Publication
(10) Pub. No.: US 2026/0085562 A1
(43) Pub. Date: Mar. 26, 2026

(54) MULTI-SLIDE SILL ASSEMBLY, AND MULTI-SLIDE PANEL SYSTEM USING SAME

(71) Applicant: Tecnoglass, Inc., Miami, FL (US)

(72) Inventors: Cameron WYATT, Gilbert, AZ (US); Samir SABAGH, Miami, FL (US); Sarah J. HARDECOPF, Gilbert, AZ (US); Daniel DAES, Key Biscayne, FL (US)

(21) Appl. No.: 19/035,364

(22) Filed: Jan. 23, 2025

Related U.S. Application Data
(60) Provisional application No. 63/558,559, filed on Feb. 27, 2024.

(51) Int. Cl. E05D 15/06; E06B 3/46

(52) U.S. Cl. CPC E05D 15/0686; E06B 3/4636; E05Y 2900/132

(57) ABSTRACT

A sill assembly for a multi-panel system, comprising a two-track base assembly having a first track portion and a second track portion. The sill assembly further comprises a first outer wall, a second outer wall opposite the first outer wall, a first female connector member extending inwardly from the first outer wall, and a second female connector member extending inwardly from the second outer wall. Additionally the first outer wall and the second outer wall define outermost surfaces of the sill assembly. Also described is a multi-slide panel system including the sill assembly.

### CROSS REFERENCE TO RELATED APPLICATIONS

The present application claims priority to U.S. Provisional Application No. 63/558,559, filed Feb. 27, 2024, which is hereby incorporated by reference herein in its entirety.

### TECHNICAL FIELD

The present disclosure generally relates to a multiple panel (e.g., window or door) system, with at least one sliding panel, and a sill assembly for use therein.

### BACKGROUND

Many current multi-slide panel systems have a sill assembly formed using a dedicated frame system, which is a large single extrusion assembly for 3 or 4 tracks, with additional single track frames that can be added on. One issue with a dedicated frame system is that a new assembly is needed for every possible multi-track configuration. Previously, 3 to 4 tracks were considered to be a large number of tracks, however, in current times multi-slide window/door systems can include up to 10 tracks. Due to multi-slide panel systems having up to 10 tracks, inventory of up to 10 different large assemblies are needed to be stocked. Additionally, these larger and larger assemblies are more and more difficult to run through assembly machinery, such as but not limited to a strut machine, and therefore can be difficult and expensive to produce. This makes dedicated track systems a bad choice for modern multi-slide panel systems.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In some aspects, the present disclosure relates to a sill assembly for a multi-panel system including a two-track base assembly having a first track portion and a second track portion. The system also includes a first outer wall and a second outer wall opposite the first outer wall, with a first female connector member extending inwardly from the first outer wall and a second female connector member extending inwardly from the second outer wall. Additionally, in the system, the first outer wall and the second outer wall define outermost surfaces of the sill assembly.

In some aspects, the present disclosure includes a multi-slide panel system having a sill assembly, a first panel member, and a second panel member. The sill assembly includes a two-track base assembly having a first track portion and a second track portion, a first outer wall and a second outer wall opposite the first outer wall, where a first female connector member extends inwardly from the first outer wall and where a second female connector member extends inwardly from the second outer wall. Also, the first outer wall and the second outer wall define outermost surfaces of the sill assembly. The first panel member is positioned on a first track of the sill assembly, and the second panel member positioned on a second track of the sill assembly, such that the second panel member is movable on the second track relative to the first panel member.

Additional aspects of the present disclosure will be discussed below.

### BRIEF DESCRIPTION OF THE DRAWINGS

FIG. 1 is a front view of an example of a multi-slide panel system including a sill assembly according to the present aspects, wherein, for example, the front view may be from an exterior of a structure in which the multi-slide panel system is mounted;

FIG. 2 is a right side view of the multi-slide panel system of FIG. 1;

FIG. 3 is a rear perspective view, relative to the front view of FIG. 1, of an example sill assembly for use with the multi-slide panel system of FIG. 1, wherein the sill assembly includes a base two track frame system sill assembly connected to one additional single track or add-a-track frame system sill assembly;

FIG. 4 is a left side view of the sill assembly of FIG. 3 in one example of connecting the add-a-track frame system sill assembly to the base two track frame system sill assembly, as illustrated by the dashed line with arrowhead;

FIG. 5 is a left side view of the base two track frame system sill assembly of FIG. 3;

FIG. 6 is a left view of the add-a-track frame system sill assembly of FIG. 3;

FIG. 7 is a left side cross-sectional view of an example of the base two track frame system sill assembly of FIG. 3 with an example panel member on one of the tracks and with the sill assembly flush mounted against flooring on, for example, an interior side;

FIG. 8 is a top view of a portion of a length of the base two track frame system sill assembly of FIG. 3, with a portion of the weatherstripping removed to expose an installation screw; and

FIG. 9 is a left side view of a portion of the base two track frame system sill assembly of FIG. 8, but with the full weatherstripping present and hiding the installation screw from view from above.

### DETAILED DESCRIPTION

Various aspects of the disclosure are now described with reference to the drawings, wherein like reference numerals are used to refer to elements throughout. In the following description, for purposes of explanation, numerous specific details are set forth in order to promote a thorough understanding of one or more aspects of the disclosure. It may be evident in some or all instances, however, that any aspects described below can be practiced without adopting the specific design details described below.

Aspects of the disclosure include a multi-panel sill assembly having a plurality of tracks to accommodate a plurality of panels, and wherein tracks may be readily added or removed to accommodate various different panel configurations. Additionally the sill assembly includes a penetrating leg channel to aid in stability of the door or panel, and allows for a location to install a weather strip. Further, the still assembly includes a base two track frame system wherein each side of the base two track frame includes a connection member. Each of the connection members may allow for an additional track portion to be attached creating a three track frame.

For instance, in one implementation, the present disclosure includes a sill assembly that comprises a base two-track frame system, which may be extended to include one or more additional tracks through connecting with one or more add-a-track frame systems. More particularly, the present disclosure includes a high performance, aluminum/polyamide multi-slide, low profile sill system that utilizes a ‘base two track’ frame system sill assembly combined with an ‘add a track’ frame system sill assembly that provides the labor savings and flexibility greater than dedicated ‘add a track’ systems or dedicated multi-track frame systems on their own. For instance, a dedicated 3 or 4 track frame system has disadvantages, and an ‘add a track’ frame system at 3 or 4 tracks has disadvantages, and the disadvantages of both have been mitigated by the frame architecture of the disclosed sill assembly. The sill assembly described provides a system that can be defined as a 2+1n track sill assembly, with n being the number of “add-a-tracks” to be added to the system.

Thus, the disclosed sill assembly provides a multi-slide panel system with a track system that is customizable and easier to produce when compared to existing solutions.

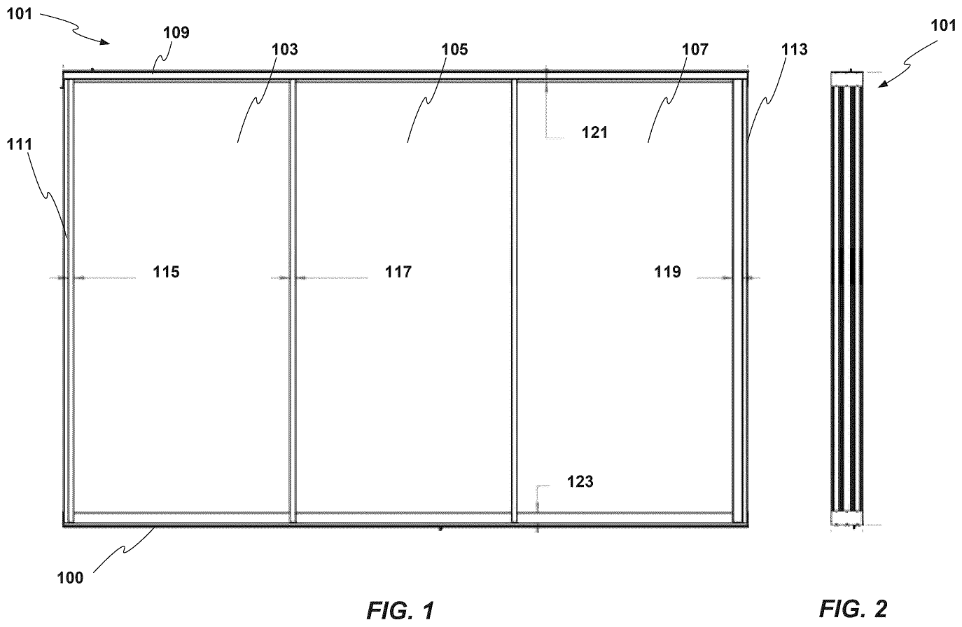

Referring to FIGS. 1 and 2, according to one example, a multi-slide panel system 101 includes a first panel 103, a second panel 105, and a third panel 107 supported within a frame system that includes a multi-track sill assembly 100 at a bottom side, a multi-track top frame 109 at a top side, and opposing end frames 111 and 113 at each end. The panels 103, 105, and 107 of the multi-slide panel system 101 may be, for example, doors and/or windows. At least one, and preferably two, of the first panel 103, the second panel 105, and the third panel 107 is/are slidably movable with the frame system. For instance, the first panel 103 may be a fixed panel, and the second panel 105 may be slidable (e.g., to the left in the example of FIG. 1) to overlap with the first panel 103, and the third panel 107 may be slidable ) to overlap with both the first panel 103 and the second panel 105. The multi-slide panel system 101 may be configured with relatively narrow frame members, compared to prior solutions, to provide a sleek, modern look that minimizes the reveal widths, e.g., a fixed panel reveal 115, an interlock reveal 117, a lead panel reveal 119, a top rail reveal 121, and a bottom rail reveal 123, thereby maximizing a view through the panels 103, 105 and 107. The panels 103, 105 and 107 may include a single or multi-pane sheet of a transparent, translucent, or non-transparent material, such as a glass, a plastic, or a wood material. In a typical example, the panels 103, 105 and 107 include two or three panes of glass, which can be sealed and filled with an insulating material therebetween, such as a gas having a lower thermal conductivity than air. An example of one such gas includes argon. In any case, the multi-track sill assembly 100 of the multi-slide panel system 101 provides an improvement over current sill assemblies, as the multi-track sill assembly 100 of the present disclosure is easily customizable to add as many tracks as needed in a manner that reduces the labor required to manufacture such a multiple track sill assembly, as is discussed in more detail below.

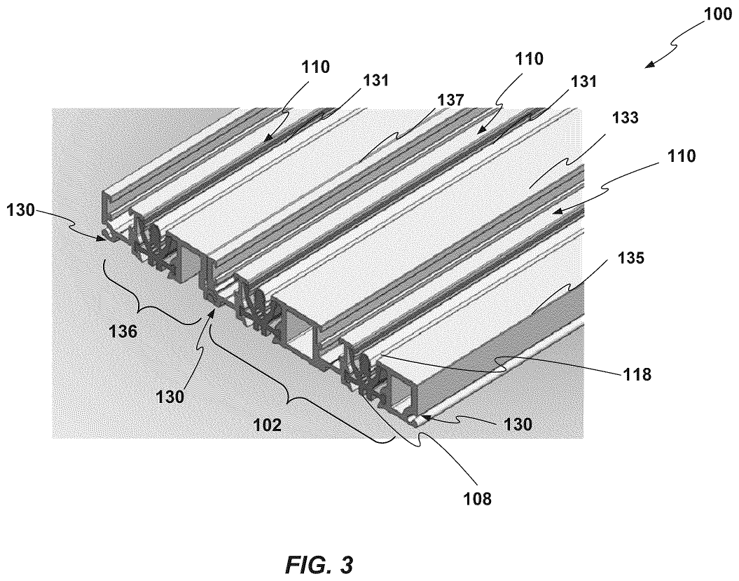

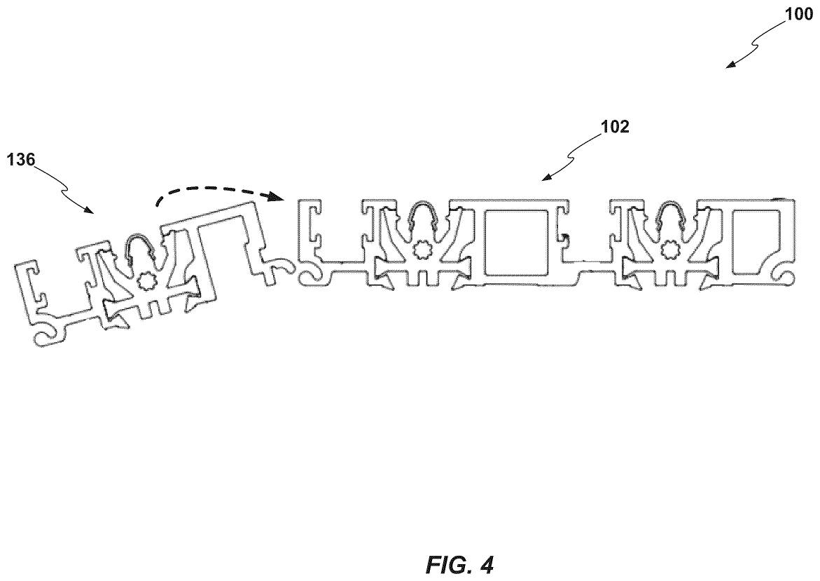

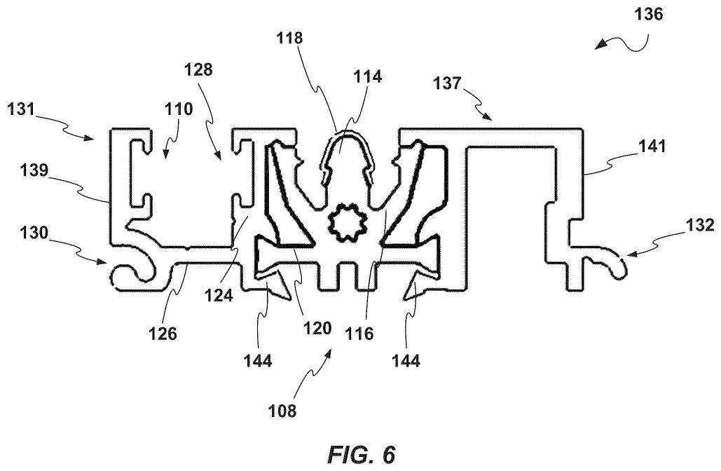

Referring to FIGS. 3-7, in the example implementation of FIG. 1, which should not be construed as limiting, the example sill assembly 100 includes a two-track base assembly 102 connected to a single track assembly 136. It should be understood, however, that the two-track base assembly 102 easily allows for a plurality of single track assemblies 136 to be attached to it, thereby creating a three-track assembly or a four-track assembly, etc. Whether the two-track base assembly 102 is used alone, or with one or more single track assemblies 136 added on, the resulting sill assembly 100 advantageously includes two opposing, outer-facing female connector members 130, which enable the easy addition of another single track assembly 136. Further, each outer-facing female connector member 130 is configured to be flush with the side walls of the sill assembly 100, which enables ease of installation with adjacent structures, such as flooring.

Referring specifically to FIGS. 3 and 4, the two-track base assembly 102 includes a first track portion 104 (see FIG. 4) and a second track portion 106 (FIG. 4) that are formed by interconnecting a plurality of frame members and struts, which can easily be connected to other track members or flush mounted to a structure or flooring. The first track portion 104 includes an end channel frame member 131 connected to an intermediate support/channel frame member 133 via a strut 108. The second track portion 106 includes the intermediate support/channel frame member 133 connected to an end support frame member 135 via another strut 108.

Advantageously, located on each of the respective outer walls of the two-track base assembly 102 are the outer-facing female connector members 130. The female connector members 130 may include, for example, a groove within each respective outer wall 139, capable of receiving a male connector. The female connector members 130 allow for additional single track assemblies 136, or any other type of accessory, to be easily and efficiently connected to the two-track base assembly 102.

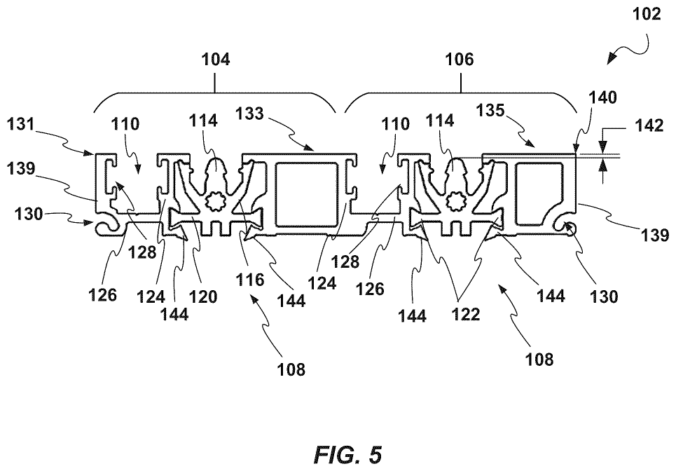

Referring specifically to FIGS. 3 and 5, the single track assembly 136 includes another end channel frame member 131 connected to an intermediate support connecting frame member 137 via another strut 108, where the intermediate support connecting frame member 137 includes a male connector member 132 configured to be connected to the female connector member 130 of the two-track base assembly 102. The male connector member 132 extends from the outer wall of the intermediate support connecting frame member 137, and has a body configured to be received in the groove of the female connector member 130 of the two-track base assembly 102. For example, in an aspect, the body of the male connector member 132 may be curved, extending downward toward a bottom of the single track assembly 136, and may fit within a similarly curved groove that defines the female connector member 130 of the two-track base assembly 102. The curved shape helps to ensure a firm connection between the single track assembly 136 and the two-track base assembly 102 in both a vertical direction and a horizontal direction. Also, the downward curve shape enables gravity and/or any force on the top of the single track assembly 136 and the two-track base assembly 102 to enhance the connection. The opposing outer wall of the additional single track assembly 136 opposite the single track male connector member 132, e.g., outer wall 139 of the end channel frame member 131, includes a further female connector member 130, as described above. Additionally, it should be noted that the end channel frame member 131 forms one end of both the two-track base assembly 102 and the single track assembly 136, and thus ensures that whether the two-track base assembly 102 is used alone, or combined with one or more single track assemblies 136, the opposing outer walls of any resulting sill assembly 100 will include the female connector members 130. Also, it should be noted that using the same component, e.g., the same end channel frame member 131, in both assemblies reduces manufacturing costs.

In an aspect, in order to reduce the transfer of thermal energy from one side (such as an exterior side) to another side (such as an interior side) of the sill assembly 100 (e.g., the two-track base assembly 102 alone or combined with one or more single track assemblies 136), the struts 108 have a first thermal conductivity that is less than a second thermal conductivity of the end channel frame member 131, the intermediate support/channel frame member 133, and the end support frame member 135. For instance, the struts 108 may be made from a plastic material, such as but not limited to a polyamide, while the end channel frame member 131, the intermediate support/channel frame member 133, and the end support frame member 135 made be made from a metal material, such as but not limited to an aluminum. It should be understood, however, that any of a plurality of different materials may be used for each of these components for different applications, and in some aspects they may be made from the same material.

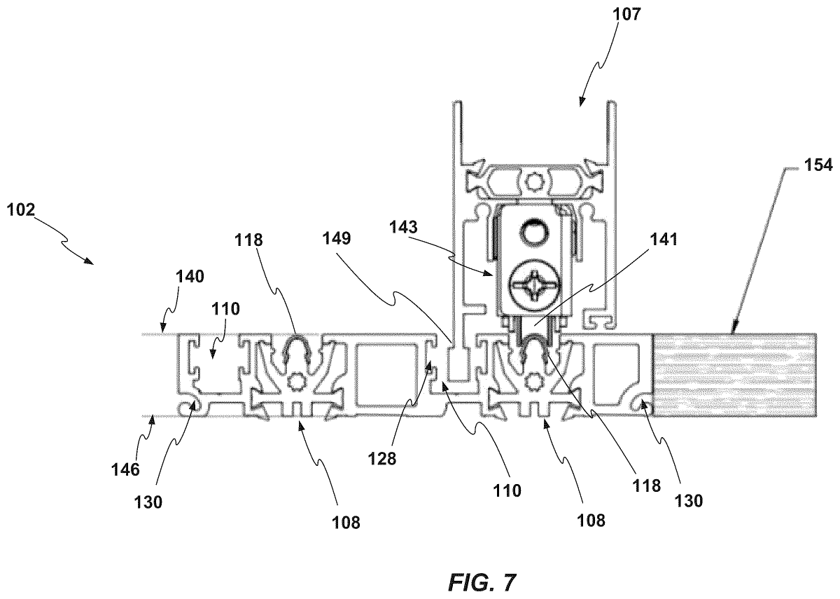

Referring specifically to FIG. 7, each strut 108 allows for one or more roller wheels 141 of a roller assembly 143 mounted on a respective one of the panel members 103, 105, and 107, such as panel member 107 in this example, to roll along the respective strut 108. As such, the struts 108 define a supporting pathway that allows one or more of the panel members 103, 105, and 107 to be easily movable between an open and closed position. It should be understood that other movement mechanisms may be used instead of roller wheels 141, such as a sliding mechanism or any other similar movement mechanism.

Referring again to FIGS. 3-7, in one example implementation, each strut 108 includes a vertically extending roller support member 114 for supporting one or more roller wheels 141 of the roller assembly 143, lateral members 120 extending from opposite sides for interconnecting with the adjacent frame members, and leg members 116 extending on opposite sides of the roller support member 114 for providing additional vertical and lateral support. Each roller support member 114 extends towards the top 140 of the sill assembly 100 (e.g., the two-track base assembly 102, and, optionally, the single track assembly 136) has an upper surface shaped to interact with the one or more roller wheels 141 of the roller assembly 143. In some implementations, the upper surface includes a curve, a channel, or one or more edges so as to additionally guide or otherwise limit lateral movement of the one or more roller wheels 141. For example, but not limited hereto, the upper surface of the roller support member 114 may have a convex shape configured to be received in a convex shaped outer surface of the one or more roller wheels 141. Further, referring to FIG. 5, each roller support member 114 may have a height that is no higher than the top 140 of the sill assembly 100 (e.g., the two-track base assembly 102, and, optionally, the single track assembly 136), and that preferably extends below to top 140 such that there is a gap 142 therebetween. This height ensures that the roller support member 114 is not damaged during manufacturing, such as during the crimping retaining tabs 144 of channels within which distal ends 122 of the lateral members 120 are contained. This causes the strut 108 to be secured within the corresponding frame member 120. Additionally, this height enables the sill assembly 100 to have a substantially flat top surface 140, which may be convenient such as when the sill assembly 100 is used in system where the panels are doors and a person may step on the sill assembly 100, allowing for a smooth transition from inside to outside, or as a threshold or along a countertop or other surface if used in a multi-slide window configuration.

In some aspects, the roller support member 114 of each strut may additionally include a cap member 118 installed to cover at least the upper surface of the roller support member 114. The cap member 118 protects the upper surface of the strut 108 from any damage that would result in reduced rolling performance, as such damage would produce variations, such as high and low points along the strut 108, thereby increasing rolling resistance. The cap member 118 may be made of metal such as stainless steel or any other high strength material that is not easily damaged. The height of the roller support member 114 including the cap member 118 may be sized such that the combined height is still no higher than the top 140 of the sill assembly 100.

The leg members 116 of each strut 108 may extend from an underside of a top surface of the adjacent frame members, and down through the body of the strut 108 to a bottom surface 146 of the sill assembly 100 (e.g., the two-track base assembly 102, and, optionally, the single track assembly 136). The top distal ends of the leg members 116 may have a curved or stepped surface that joins or locks with a corresponding surface on the underside of the top surface of the adjacent frame members, which may help to provide additional lateral support to fix together the assembly.

Located adjacent to each strut 108 on one side is a channel member 110 configured to act as a gutter to drain water dripping down from an exterior surface of a respective panel member (see, e.g., FIG. 7). For instance, the channel member 110 is on the outside of each panel member, so as rain sheets off the panel member, the channel member 110 is used as a rain gutter for the weeps. Further, in some aspects, each channel member 110 may be configured to receive a lower wall extension 149 (see FIG. 7) of a respective panel member, such as panel member 107 in this example. By receiving the lower wall extension 149, each channel member 110 helps to enhance to look of the multi-slide panel system 101, and also the projection of the lower wall extension 149 into the channel member 110 helps to ensure water drains into the channel member 110. Each channel member 110 includes at least two side walls 124 and a bottom wall 126.

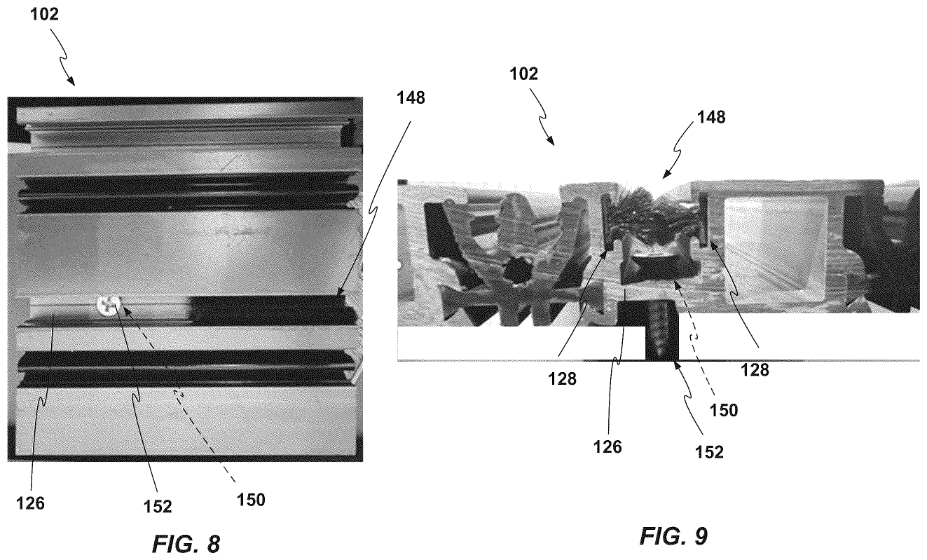

Referring additionally to FIGS. 8 and 9, in some aspects, each of the side walls 124 of the channel member 110 may optionally incudes a groove member 128 each configured to hold a respective weather strip 148. Additionally, the bottom wall 126 may include one or more openings 150 to allow for the sill assembly 100 to be affixed or installed to a designated surface via one or more securing mechanisms 152, such as but not limited to screws. Additionally, the securing mechanisms 152 are easily concealable by the weather strips 148 located along the side walls and the consumer will therefore not see visible securing mechanisms 152. Apart from concealing the securing mechanisms 152,the weather strips 148 serve to further insulate and protect the opposing sides of the panel members. For example, the sill assembly 100 may be installed to the floor for a sliding door. In this example, the bottom wall 126 of the channel member 110 may be screwed into or otherwise secured to the floor. Further weather strips 148 may secured into the groove members 128 of the side walls 124. The weather strips 148 and channel member 110 may serve to prevent elements such as hot or cold air, and/or water, from the outside side of the panel members to affect or reach the inside side of the panel members.

Located adjacent to the strut 108 on the side opposite of the channel member 110 is a support frame member, such as the support member portion of the intermediate support/channel frame member 133, the end support frame member 135, or the intermediate support connecting frame member 137. Each respective support frame member serves as additional support structure for the sill assembly 100. Additionally, each support frame member provides additional insulation between the different sides, such as inside and outside, of the panel members.

Further, each component of the two-track base assembly 102 and the single track assembly 136 of the sill assembly 100 extend to a same height and are therefore flush with one another. This allows for the sill assembly 100 to be easily traversed when using sliding doors with a high number of tracks or to be usable with a sliding window on a countertop, among other options.

The sill assembly 100 described above always allows for respective female connectors 130 to be on each side of the sill assembly 100. This means the outer walls of the sill assembly 100 will always be flush on the outside and will therefore be easy to install into an adjacent structure 154 (see FIG. 7), such as a floor or a counter top, as there will never be a male connector member extending out of an outside wall portion of the sill assembly 100. Additionally, this allows for a highly customizable sill assembly 100 that can accommodate any number of movable panel members as additional single track assemblies can be added providing additional tracks for additional panel members as necessary.

One more aspects of the present disclosure may be implemented according to one or more of the following clauses.

Clause 1. A sill assembly for a multi-panel system, comprising: a two-track base assembly having a first track portion and a second track portion; a first outer wall; a second outer wall opposite the first outer wall; a first female connector member extending inwardly from the first outer wall; a second female connector member extending inwardly from the second outer wall; and wherein the first outer wall and the second outer wall define outermost surfaces of the sill assembly.

Clause 2. The sill assembly of clause 1, wherein the first track portion comprises an end channel frame member connected to an intermediate support/channel frame member via a first strut, and wherein the second track portion includes the intermediate support/channel frame member connected to an end support frame member via a second strut.

Clause 3. The sill assembly of any preceding clause, wherein an end channel frame outer wall of the end channel frame member comprises the first outer wall, and an end support frame outer wall of the end support frame member comprises the second outer wall.

Clause 4. The sill assembly of any preceding clause, wherein a top surface of both the first strut and the second strut is at or below a plane corresponding to a top surface of the sill assembly.

Clause 5. The sill assembly of any preceding clause, further comprising a single track assembly connected to the two-track base assembly.

Clause 6. The sill assembly of any preceding clause, wherein the single track assembly includes an end channel frame member connected to an intermediate support connecting frame member via a strut, wherein the intermediate support connecting frame member includes a male connector member configured to be connected to either the first female connector member or the second female connector member of the two-track base assembly.

Clause 7. The sill assembly of any preceding clause, wherein an end channel frame outer wall of the end channel frame member comprises the first outer wall.

Clause 8. The sill assembly of any preceding clause, wherein the male connector member of the single track assembly comprises a downwardly curved body, and wherein the first female connector member and the second female connector member of the two-track base assembly comprise a downwardly curved groove.

Clause 9. The sill assembly of any preceding clause, wherein the single track assembly comprises a first single track assembly, wherein the first single track assembly comprises a third female connector member, and further comprising a second single track assembly connected to the first single track assembly.

Clause 10. A multi-slide panel system, comprising: a sill assembly including: a two-track base assembly having a first track portion and a second track portion; a first outer wall; a second outer wall opposite the first outer wall; a first female connector member extending inwardly from the first outer wall; a second female connector member extending inwardly from the second outer wall; and wherein the first outer wall and the second outer wall define outermost surfaces of the sill assembly; and a first panel member positioned on a first track of the sill assembly; and a second panel member positioned on a second track of the sill assembly, wherein the second panel member is movable on the second track relative to the first panel member.

Clause 11. The multi-slide panel system of clause 10, wherein the first track portion comprises an end channel frame member connected to an intermediate support/channel frame member via a first strut, and wherein the second track portion includes the intermediate support/channel frame member connected to an end support frame member via a second strut.

Clause 12. The multi-slide panel system of any preceding clause, wherein an end channel frame outer wall of the end channel frame member comprises the first outer wall, and an end support frame outer wall of the end support frame member comprises the second outer wall.

Clause 13. The multi-slide panel system of any preceding clause, wherein a top surface of both the first strut and the second strut is at or below a plane corresponding to a top surface of the sill assembly.

Clause 14. The multi-slide panel system of any preceding clause, further comprising a single track assembly connected to the two-track base assembly.

Clause 15. The multi-slide panel system of any preceding clause, wherein the single track assembly includes an end channel frame member connected to an intermediate support connecting frame member via a strut, wherein the intermediate support connecting frame member includes a male connector member configured to be connected to either the first female connector member or the second female connector member of the two-track base assembly.

Clause 16. The multi-slide panel system of any preceding clause, wherein an end channel frame outer wall of the end channel frame member comprises the first outer wall.

Clause 17. The multi-slide panel system of any preceding clause, wherein the male connector member of the single track assembly comprises a downwardly curved body, and wherein the first female connector member and the second female connector member of the two-track base assembly comprise a downwardly curved groove.

Clause 18. The multi-slide panel system of any preceding clause, wherein the single track assembly comprises a first single track assembly, wherein the first single track assembly comprises a third female connector member, and further comprising a second single track assembly connected to the first single track assembly.

In general, the description of the aspects disclosed should be considered as being illustrative in all respects and not being restrictive. The scope of the present disclosure is shown by the claims rather than by the above description, and is intended to include meanings equivalent to the claims and all changes in the scope. While preferred aspects of the disclosure have been described above, it is to be understood that variations and modifications will be apparent to those skilled in the art without departing from the scope and spirit of the disclosure.

What is claimed is:

1. A sill assembly for a multi-panel system, comprising:
a two-track base assembly having a first track portion and a second track portion;
a first outer wall;
a second outer wall opposite the first outer wall;
a first female connector member extending inwardly from the first outer wall;
a second female connector member extending inwardly from the second outer wall; and
wherein the first outer wall and the second outer wall define outermost surfaces of the sill assembly.

2. The sill assembly of claim 1, wherein the first track portion comprises an end channel frame member connected to an intermediate support/channel frame member via a first strut, and wherein the second track portion includes the intermediate support/channel frame member connected to an end support frame member via a second strut.

3. The sill assembly of claim 2, wherein an end channel frame outer wall of the end channel frame member comprises the first outer wall, and an end support frame outer wall of the end support frame member comprises the second outer wall.

4. The sill assembly of claim 2, wherein a top surface of both the first strut and the second strut is at or below a plane corresponding to a top surface of the sill assembly.

5. The sill assembly of claim 1, further comprising a single track assembly connected to the two-track base assembly.

6. The sill assembly of claim 5, wherein the single track assembly includes an end channel frame member connected to an intermediate support connecting frame member via a strut, wherein the intermediate support connecting frame member includes a male connector member configured to be connected to either the first female connector member or the second female connector member of the two-track base assembly.

7. The sill assembly of claim 6, wherein an end channel frame outer wall of the end channel frame member comprises the first outer wall.

8. The sill assembly of claim 6, wherein the male connector member of the single track assembly comprises a downwardly curved body, and wherein the first female connector member and the second female connector member of the two-track base assembly comprise a downwardly curved groove.

9. The sill assembly of claim 5, wherein the single track assembly comprises a first single track assembly, wherein the first single track assembly comprises a third female connector member, and further comprising a second single track assembly connected to the first single track assembly.

10. A multi-slide panel system, comprising:
a sill assembly including:
a two-track base assembly having a first track portion and a second track portion;
a first outer wall;
a second outer wall opposite the first outer wall;
a first female connector member extending inwardly from the first outer wall;
a second female connector member extending inwardly from the second outer wall; and
wherein the first outer wall and the second outer wall define outermost surfaces of the sill assembly; and
a first panel member positioned on a first track of the sill assembly; and
a second panel member positioned on a second track of the sill assembly, wherein the second panel member is movable on the second track relative to the first panel member.

11. The multi-slide panel system of claim 10, wherein the first track portion comprises an end channel frame member connected to an intermediate support/channel frame member via a first strut, and wherein the second track portion includes the intermediate support/channel frame member connected to an end support frame member via a second strut.

12. The multi-slide panel system of claim 11, wherein an end channel frame outer wall of the end channel frame member comprises the first outer wall, and an end support frame outer wall of the end support frame member comprises the second outer wall.

13. The multi-slide panel system of claim 11, wherein a top surface of both the first strut and the second strut is at or below a plane corresponding to a top surface of the sill assembly.

14. The multi-slide panel system of claim 10, further comprising a single track assembly connected to the two-track base assembly.

15. The multi-slide panel system of claim 14, wherein the single track assembly includes an end channel frame member connected to an intermediate support connecting frame member via a strut, wherein the intermediate support connecting frame member includes a male connector member configured to be connected to either the first female connector member or the second female connector member of the two-track base assembly.

16. The multi-slide panel system of claim 15, wherein an end channel frame outer wall of the end channel frame member comprises the first outer wall.

17. The multi-slide panel system of claim 15, wherein the male connector member of the single track assembly comprises a downwardly curved body, and wherein the first female connector member and the second female connector member of the two-track base assembly comprise a downwardly curved groove.

18, The multi-slide panel system of claim 14, wherein the single track assembly comprises a first single track assembly, wherein the first single track assembly comprises a third female connector member, and further comprising a second single track assembly connected to the first single track assembly.
